(19) United States
(12) Patent Application Publication
(10) Pub. No.: US 2011/0296213 A1
(43) Pub. Date: Dec. 1, 2011

(54) Enterprise power management method and system and power manager for use therein

(76) Inventors: Andrew Rodney Ferlitsch, Camas, WA (US); Basil Isaiah Jesudason, Portland, OR (US)

(21) Appl. No.: 12/802,126

(22) Filed: May 28, 2010

(51) Int. Cl. G06F 1/32; G06F 1/00

(52) U.S. Cl. 713/320; 713/300

(57) ABSTRACT

A method and system for managing power in an enterprise environment based on individual office worker schedules. In one aspect, the system includes a power manager, a plurality of client devices operatively coupled with the power manager and a plurality of managed elements operatively coupled with the power manager, wherein the power manager receives from the client devices individual worker schedule information and generates based at least in part on the individual worker schedule information a list of scheduled events having associated managed elements and power profiles, and wherein in response to a start time of a scheduled event the power manager adjusts a power state of one or more managed elements associated with the scheduled event in accordance with a power profile associated with the scheduled event.

### BACKGROUND OF THE INVENTION

The present invention relates to power management in enterprise environments and, more particularly, to a method and system for regulating power in an enterprise environment based on individual worker schedules, and a power manager for facilitating such a method and system.

Conventionally, power management in an enterprise environment has been largely manual. Office workers have been responsible for powering-up office appliances [e.g. personal computers (PCs), coffee makers, etc.] and overhead lights when they enter offices and meeting rooms and for powering-down office appliances and overhead lights when they exit offices and meeting rooms. Unfortunately, office workers often neglect to power-down appliances and overhead lights upon egress, resulting in a substantial waste of energy.

Some office appliances and overhead lights support automated power management. For example, office appliances may have a setting that causes them to power-down after an idle time. However, the power state changes in these appliances are generally not coordinated with the schedule (e.g. work hours, breaks, meetings, etc.) of the office worker who is the primary user of the appliance. Moreover, automated power management in these appliances is generally not integral with other appliances. That is, an idle timeout only causes a single appliance to power-down.

One improvement in automated power management has been support for reduced power states. For example, if an office appliance that supports a reduced power state is idle for a first time period, the appliance may enter a reduced power state (e.g. standby) from which it can quickly return to full power. If the appliance remains idle for a second time period, the appliance may power-off. While support for reduced power states has yielded substantial energy savings, it has not remedied the lack of coordination of power state changes with the primary user's schedule and/or lack of integration with other appliances.

Another improvement in automated power management has been support for concerted action by groups of appliances. For example, a software utility may power-down a fleet of office appliances at a first time of day (e.g. end of workday) and power-up the fleet at a second time of day (e.g. start of workday). However, appliance groups configured for concerted action have tended to be homogenous (e.g. printer group). Moreover, concerted action by appliance groups has not addressed the lack of coordination between the power state changes and the primary user's schedule.

### SUMMARY OF THE INVENTION

The present invention, in a basic feature, provides a method and system for regulating power in an enterprise environment based on individual office worker schedules. In one aspect of the invention, a method for enterprise power management comprises the steps of receiving by a power manager from a plurality of client devices individual worker schedule information; generating by the power manager based at least in part on the individual worker schedule information a list of scheduled events having associated managed elements and power profiles; and in response to a start time of a scheduled event, adjusting by the power manager a power state of one or more managed elements associated with the scheduled event in accordance with a power profile associated with the scheduled event.

In some embodiments, the power manager conditions adjustment of the power state on a detection of presence.

In some embodiments, the power manager alerts a client device associated with the scheduled event and provides an opportunity to override the adjustment.

In some embodiments, in response to an end time of a scheduled event, the power manager readjusts a power state of one or more managed elements associated with the scheduled event.

In some embodiments, the power manager conditions readjustment of the power state on a detection of presence.

In some embodiments, the power manager alerts a client device associated with the scheduled event and provides an opportunity to override the readjustment.

In some embodiments, the power manager selects power profiles for scheduled events based at least in part on event duration.

In some embodiments, the scheduled event is an absent worker event, and the power manager, in response to a start time of the absent worker event, adjusts the power state of one or more managed elements in an office of a worker scheduled to be absent.

In some embodiments, the scheduled event is a meeting event, and the power manager, in response to a start time of the meeting event, adjusts the power state of one or more managed elements in a meeting room where a meeting is scheduled to be held and the power state of one or more managed elements in an office of a worker scheduled to attend the meeting.

In some embodiments, the individual worker schedule information is generated by calendaring software running on the client devices.

In some embodiments, the individual worker schedule information is generated by calendaring software running on a network connected service.

In some embodiments, the one or more managed elements include a personal computer (PC), a PC monitor and an overhead light.

In some embodiments, the power manager adjusts the power state of one or more managed elements to a reduced power state.

In another aspect of the invention, a power manager comprises a plurality of communication interfaces; and a processor communicatively coupled with the communication interfaces, wherein under control of the processor the power manager receives from a plurality of client devices via one or more of the communication interfaces individual worker schedule information and generates based at least in part on the individual worker schedule information a list of scheduled events having associated managed elements and power profiles, and wherein under control of the processor in response to a start time of a scheduled event the power manager adjusts using signals transmitted on one or more of the communication interfaces a power state of one or more managed elements associated with the scheduled event in accordance with a power profile associated with the scheduled event.

In some embodiments, under control of the processor the power manager conditions adjustment of the power state on a detection of presence.

In some embodiments, under control of the processor the power manager alerts a client device associated with the scheduled event and provides an opportunity to override the adjustment.

In some embodiments, under control of the processor the power manager selects power profiles for scheduled events based at least in part on event duration.

In some embodiments, the scheduled event is an absent worker event, and under control of the processor in response to a start time of the absent worker event the power manager adjusts using signals transmitted on one or more of the communication interfaces the power state of one or more managed elements in an office of a worker scheduled to be absent.

In some embodiments, the scheduled event is a meeting event, and under control of the processor in response to a start time of the meeting event the power manager adjusts using signals transmitted on or more of the communication interfaces the power state of one or more managed elements in a meeting room where a meeting is scheduled to be held and the power state of one or more managed elements in an office of a worker scheduled to attend the meeting.

In some embodiments, the individual worker schedule information is generated by calendaring software running on the client devices.

In some embodiments, the individual worker schedule information is generated by calendaring software running on a network connected service.

In some embodiments, the one or more managed elements include a PC, a PC monitor and an overhead light and the power manager adjusts the power state of the PC, the PC monitor and the overhead light to a reduced power state.

In yet another aspect of the invention, a system for enterprise power management comprises a power manager, a plurality of client devices operatively coupled with the power manager and a plurality of managed elements operatively coupled with the power manager, wherein the power manager receives from the client devices individual worker schedule information and generates based at least in part on the individual worker schedule information a list of scheduled events having associated managed elements and power profiles, and wherein in response to a start time of a scheduled event the power manager adjusts a power state of one or more managed elements associated with the scheduled event in accordance with a power profile associated with the scheduled event.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows elements involved in event scheduling in an enterprise power management system in some embodiments of the invention.

FIG. 2 shows elements involved in power state adjustment in an enterprise power management system in some embodiments of the invention.

FIG. 3 shows contents of a schedule database in some embodiments of the invention.

FIG. 4 shows method steps performed by a power manager to schedule an absent worker event in some embodiments of the invention.

FIG. 5 shows method steps performed by a power manager to schedule a meeting event in some embodiments of the invention.

FIG. 6 shows method steps performed by a power manager to adjust a power state of managed elements in an office of a worker during and after a scheduled short-term absence in some embodiments of the invention.

FIG. 7 shows method steps performed by a power manager to adjust a power state of managed elements in an office of a worker during and after a scheduled medium-term absence in some embodiments of the invention.

FIG. 8 shows method steps performed by a power manager to adjust a power state of managed elements in an office of a worker during and after a scheduled long-term absence in some embodiments of the invention.

FIG. 9 shows method steps performed by a power manager to adjust a power state of managed elements in an meeting room during and after a scheduled meeting in some embodiments of the invention.

### DETAILED DESCRIPTION OF A PREFERRED EMBODIMENT

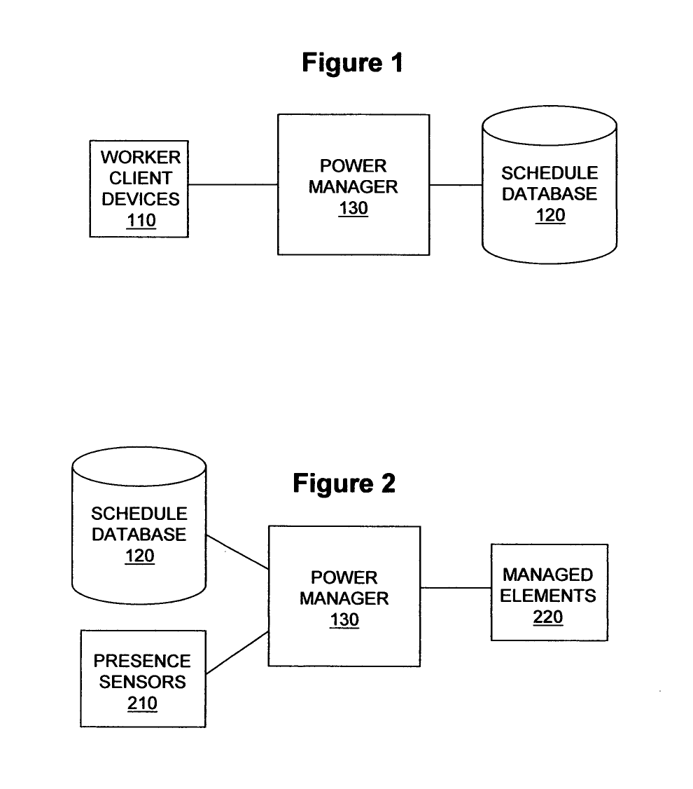

FIG. 1 shows elements involved in event scheduling in an enterprise power management system in some embodiments of the invention. The elements include worker client devices 110, a schedule database 120 and a power manager 130. Worker client devices 110 and schedule database 120 communicate with power manager 130 over a wireless or wired data link using a known communication protocol, such WiFi, Bluetooth, Ethernet, or ZigBee. The enterprise power management system may span one or more worksites of an organization, such as a company, nonprofit entity, governmental entity or academic, charitable or religious institution.

Worker client devices 110 may be of various network-capable computing device types, such as desktop PCs, laptops, multifunction peripherals (MFPs) and smart mobile devices (e.g. iPhone, iTouch, iPad, etc.). The number of worker client devices 110 will generally vary with the number of onsite workers in the organization. Worker client devices 110 each have a processor adapted to run calendaring software, such as Microsoft Outlook 2007, and plug-in software that exports individual worker schedule information inputted by workers into the calendaring software to power manager 130 via network interfaces on worker client devices 110. A Microsoft.Net model in C# and Visual Basic (e.g., Microsoft.Office.Interop.Outlook API) may be used to add the plug-in to Microsoft Office 2007.

Power manager 130 may be a server device in the organization's network, or an external device that runs as part of a cloud service. Power manager 130 has one or more network interfaces adapted to import individual worker schedule information from worker client devices 110 and a processor adapted to run software that uses the individual worker schedule information to regulate power in the enterprise power management system. Power manager 130 may import the worker schedule information on an exposed Web service that runs under processor control and that is accessible to the plug-in software on worker client devices 110.

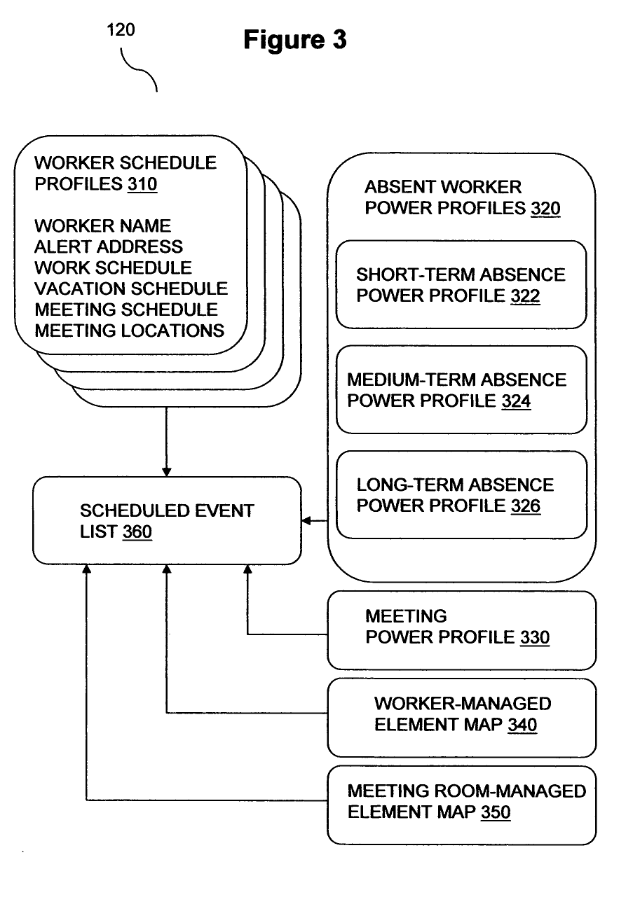

Turning to FIG. 3, contents of schedule database 120 are shown. Power manager 130 under processor control maintains in schedule database 120 worker schedule profiles 130 for individual workers. Worker schedule profiles 130 include individual worker schedule information imported by power manager 130 from worker client devices 110, such as the worker's name, work schedule (e.g. work hours, break times, lunch times), vacation schedule, company holiday schedule, personal appointment schedule, meeting schedule and meeting locations. In some embodiments, worker schedule profiles 310 include seven tables for each worker, one for each day of the week, wherein each table has a field for start of workday, end of workday, start of lunch, end of lunch, a flag indicating if lunch is eaten out of the office, time of morning break, duration of morning break, a flag indicating if the morning break is taken out of the office, time of afternoon break, duration of afternoon break, and a flag indicating if the afternoon break is taken out of the office. In other embodiments, worker schedule profiles 310 include one table for each worker that has a chained list of information fields. In these embodiments, the worker's name is used as a primary key and the day of the week is included as an additional field.

Power manager 130 under processor control applies worker schedule profiles 130 in conjunction with absent worker power profiles 320, a meeting power profile 330, a worker-managed element map 340 and a meeting room-managed element map 350 to create a scheduled event list 360. For example, where a worker's schedule profile indicates that the worker takes a scheduled break between 10:00 a.m. and 10:15 a.m., power manager 130 may consult worker-managed element map 340 to identify managed elements in the worker's office whose power state will be adjusted downward when the worker goes on break, such as a PC, a PC monitor, printer, certain appliances connected to wall plugs and overhead lights. Power manager 130 may then consult a short-term absence power profile 322 to determine system-wide power state adjustment rules applicable to PCs, PC monitors, printers, selected wall-powered devices and overhead lights during short-term worker absences, such as “put PC into standby state,” “put PC monitor into deep sleep state,” “power-off managed wall-powered appliances” and “dim overhead lights.” Power manager 130 may then create an absent worker event in scheduled event list 360 having a start time of 10:00 am., an end time of 10:15 a.m. and power state adjustments to be made in the worker's office at start time to conserve power, such as putting the worker's PC into standby state, putting the worker's PC monitor into deep sleep state, powering-off the managed wall-powered appliances and dimming the overhead lights. More generally, scheduled event list 360 includes, for each scheduled event, an event start time, an event end time and power state adjustment instructions for managed elements.

FIG. 2 shows elements involved in power state adjustment in the enterprise power management system in some embodiments of the invention. The elements include schedule database 120, presence sensors 210 and managed elements 220, all of which are communicatively coupled with power manager 130. Power manager 130 under processor control monitors scheduled event list 360 and, in response to an event start time, adjusts the power state of managed elements 220 affected by the event in accordance with a power profile assigned to the event. Power state adjustments may be conditioned on detection of human presence by presence sensors 210, as will be explained in more detail.

Presence sensors 210 may include various devices that are capable of detecting human presence, such as a card swipe access control system that regulates access to a building, office or meeting room; a motion detector in an office or meeting room, and a PC that detects activity on a peripheral device, such as a keyboard or mouse. Presence sensors 210 may communicate with power manager 130 over a wireless or wired data link using a known communication protocol, such as WiFi, Bluetooth, Ethernet, or ZigBee.

Managed elements 220 may include various appliance types, such as PCs, PC monitors, MFPs, adding machines, clocks, coffee makers, compact disc players, conferencing phones, desk lamps, digital video disc players, fans, fax machines, floor lamps, printers, refrigerators and scanners, and may also include overhead lights. The number of managed elements will generally vary with the size of the organization. Managed elements 220 may communicate with power manager 130 over a power line, a wireless data link or wired data link, using any suitable communication protocol, such as ZigBee, X10, WiFi, Bluetooth, or Ethernet. In one example, power manager 130 may send a ZigBee command to a managed element over a wireless data link instructing the managed element to power-off. In response, a ZigBee module on the managed element may send a command to a power state controller associated with the managed element that switches-off power through a solid state relay. The power state controller may also monitor power usage by the managed element through a current transducer clamp and transmit information on power usage to power manager 130 via the ZigBee module. Power manager 130 may then determine the worker who operates the managed element by reference to worker-managed element map 340 and deliver power usage information to a worker client device operated by the worker. In other examples, an X10 power management module or smart plug may be invoked to regulate supply of power to managed elements.

Some of managed elements 220 may support reduced power states. For example, a managed PC may support a fully powered state, a standby state and a deep sleep state, a hibernation state and a shutdown state. The standby state may be a moderately reduced power state in which hard drives are powered-off and the processor clock speed is reduced. The PC may be returned to a fully powered state by keyboard or mouse activity. The deep sleep state may be an extreme reduced power state in which the PC's network interface card remains operative while all other functions are powered-off. The PC may be returned to a fully powered state by transmitting a wakeup-on-LAN command to the network interface card. The hibernation state may be a powered-off state where the current state of operation (e.g. files opened, applications running, etc.) is preserved. When the PC is rebooted, the current state of operation is restored. The shutdown state may be a powered-off state where the current state of operation is not preserved. When the PC is rebooted, the default state is assumed. Alternatively, a managed PC monitor may support a fully powered state, a deep sleep state and a shutdown state. The deep sleep state may an extreme reduced power state in which only the video signal input port remains operative. The PC monitor may be returned to a fully powered state by activity on the video signal input port from the PC. In yet another example, a managed MFP may support one or both of a standby state and a deep sleep state.

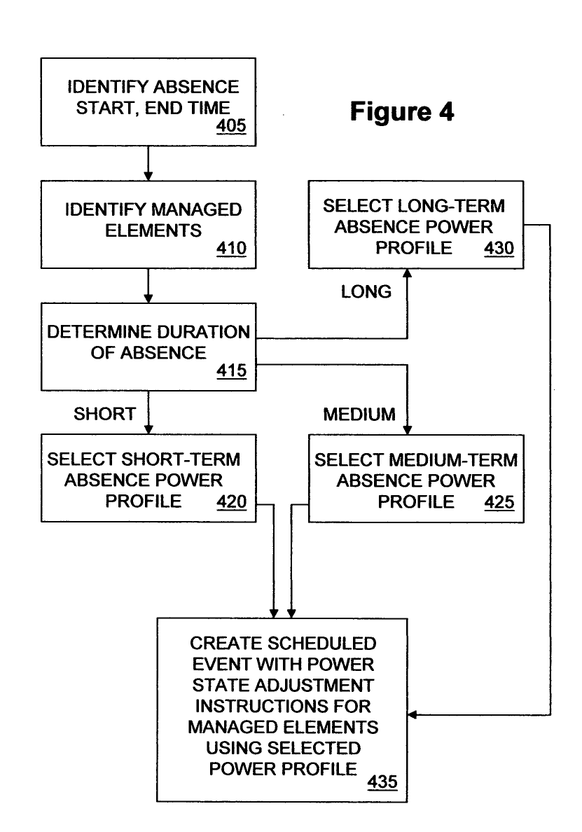

Turning to FIG. 4, method steps performed by power manager 130 under processor control to schedule an absent worker event are shown in some embodiments of the invention. Initially, power manager 130 identifies a start and end time of a worker's absence from worker schedule information stored in the worker's schedule profile (405). The absence may be identified by reference to the worker's scheduled work hours, break times, lunch time, vacation schedule or appointment schedule, by way of example.

Next, power manager 130 identifies the worker's managed elements from worker-managed element map 340 (410). The managed elements may include, for example, a PC, a PC monitor, a printer, certain wall-powered appliances (e.g. fan) and overhead lights in the worker's office.

Next, power manager 130 determines the duration of the worker's absence from the absence start and end times (415). If the duration is short, power manager 130 selects short-term absence power profile 322 for application in determining downward power state adjustments to be made to the worker's managed elements (420). If the duration is medium, power manager 130 selects medium-term absence power profile 324 for application in determining downward power state adjustments that will be made to the worker's managed elements (425). If the duration is long, power manager 130 selects long-term absence power profile 326 for application in determining downward power state adjustments that will be made to the managed elements (430). By way of example, an absence of less than an hour may be classified as a short-term absence, an absence of more than an hour but less than a day may be classified as a medium-term absence and an absence of more than a day may be classified as a long-term absence. Power profiles 322, 324, 326 specify different downward power adjustment rules for different lengths of absence. For example, short-term absence power profile 322 may specify to put the managed PC in a standby state, medium-term absence power profile 324 may specify to put the managed PC in a deep sleep state, and long term absence power profile 326 may specify to power-off the managed PC.

Finally, power manager 130 creates an absent worker event in scheduled event list 360. The absent worker event includes instructions to adjust downward, at the event start time, the power state of the worker's managed elements as specified in the selected one of power profiles 322, 324, 326 (435).

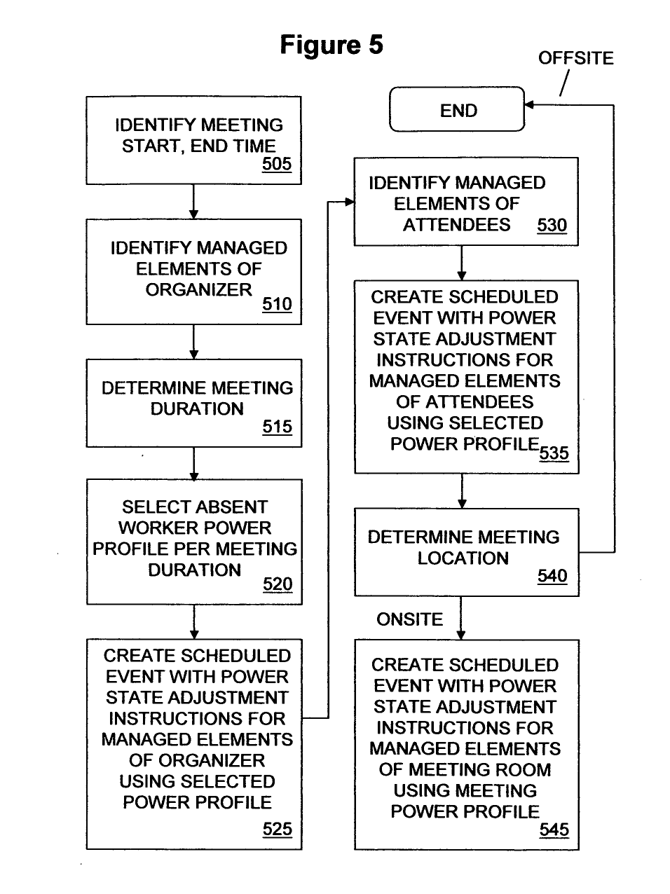

FIG. 5 shows method steps performed by power manager 130 under processor control to schedule a meeting event in some embodiments of the invention. Initially, power manager 130 identifies a meeting start and end time by reference to worker schedule information in a worker schedule profile of a meeting organizer (505).

Next, power manager 130 identifies the meeting organizer's managed elements from worker-managed element map 340 (510). The identified managed elements may include, for example, a PC, a PC monitor, a printer, certain wall-powered appliances (e.g. fan) and overhead lights in the meeting organizer's office.

Next, power manager 140 determines the duration of the meeting from the meeting start and end time (515) and selects an absent worker power profile based on the meeting duration (520). An absent worker power profile is selected from among short-term absence power profile 322, medium-term power profile 324 and long-term power profile 326 as described above in relation to FIG. 4.

Next, power manager 130 creates an absent worker event in scheduled event list 360 that includes instructions to adjust downward the power state of the meeting organizer's managed elements at the meeting start time as specified in the selected one of power profiles 322, 324, 326 (525). This event is created to conserve power in the meeting organizer's office while the meeting organizer is attending the meeting.

Next, power manager 130 identifies managed elements of other workers (if any) within the organization whom are scheduled to attend the meeting from other worker schedule profiles and worker-managed element map 340 (530).

Next, power manager 130 creates additional absent worker events in scheduled event list 360 that include instructions to adjust downward the power state of the managed elements of other meeting attendees at the meeting start time as specified in the selected one of power profiles 322, 324, 326 (535). These events are created to conserve power in the offices of the other meeting attendees while they attend the meeting.

Next, power manager 130 determines the meeting location from worker schedule information in the meeting organizer's worker schedule profile (540). If the meeting is scheduled to take place at an offsite location that is not under the power management of this system, there is no opportunity to regulate the power state of managed elements in the meeting room, and so the flow ends. On the other hand, if the meeting is scheduled to take place at an onsite location or offsite location under this power management system, there is opportunity to regulate the power state of managed elements in the meeting room, and the flow proceeds. Particularly, power manager 130 creates a meeting event in scheduled event list 360 that includes instructions to adjust upward, at the meeting event start time, the power state of managed elements in the meeting room as specified in meeting power profile 330 (435). Managed elements in the meeting room are identified from meeting room-managed element map 350. Managed elements in the meeting room may include, for example, a meeting room PC, meeting room PC monitor, printer, projector, electronic whiteboard, certain wall-powered appliances (e.g. video/audio conferencing phone) and overhead lights.

In some embodiments, power manager 130 may determine whether the scheduled meeting location is the meeting organizer's or a meeting attendee's office, and if the scheduled meeting location is in the meeting organizer's or a meeting attendee's office may inhibit scheduling of an absent worker event for the meeting organizer or meeting attendee who will host the meeting.

In some embodiments, to realize additional power savings, an absent worker event may instruct to adjust downward the power state of the meeting organizer's and/or meeting attendees' managed elements at a predetermined time before the meeting start time to account for travel time from the meeting organizer's and/or meeting attendees' respective offices to the meeting location. Where the meeting location is offsite, a travel distance calculator may be used to deduce travel times. If the travel time exceeds a predetermined threshold time, power manager 130 may presume that the meeting organizer and/or meeting attendee will be away from the office for the entire day and select long-term absence power profile 326 for application to their respective managed elements.

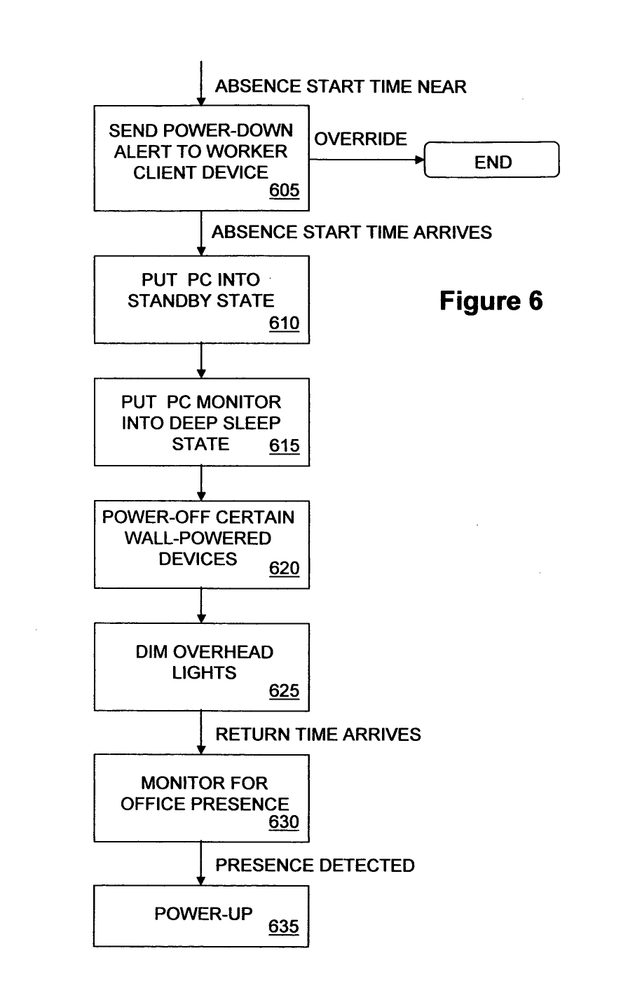

FIG. 6 shows method steps performed by power manager 130 under processor control to adjust a power state of managed elements in an office of a worker during and after a scheduled short-term absence in some embodiments of the invention. The managed elements in this example are a PC, PC monitor, certain wall-powered appliances (e.g. fan) and overhead lights in the worker's office.

Power manager 130 continually monitors scheduled event list 360 for event start times. At a predetermined time before a start time of a scheduled absent worker event, power manager 130 transmits a power-down alert to an alert address designated in the worker's schedule profile (605). The alert address may be, for example, a web services client interface address on the worker's PC that is callable by a web service on power manager 130, an IP address of the worker's PC, the worker's email address, or the workers cell phone number. The alert notifies the worker of an impending downward power state adjustment and provides the worker an opportunity to override the adjustment by returning an override notification before the event start time, such as by pushing an override button in an alert pop-up window of a web services alert, replying to an email alert with an override notification, or replying to a text message alert with an override notification.

If power manager 130 receives an override notification before the event start time, power state adjustments to the worker's managed elements are canceled.

If power manager 130 does not receive an override notification before the event start time, power state adjustments proceed at the event start time in accordance with short-term absence power profile 322 as follows: Power manager 130 puts the worker's PC into a standby state (610), puts the worker's PC monitor into a deep sleep state (615), powers-off the worker's wall-powered appliances (620) and dims the worker's overhead lights (625).

When the event end time arrives, power manager 130 begins to monitor presence sensors 210 for human presence in the worker's office (630). Once power manager 130 detects presence, power manager 130 performs power state readjustments that power-up the worker's managed elements. For example, power manager 130 may return the worker's PC, PC monitor, wall-powered appliances and/or overhead lights to a full power state.

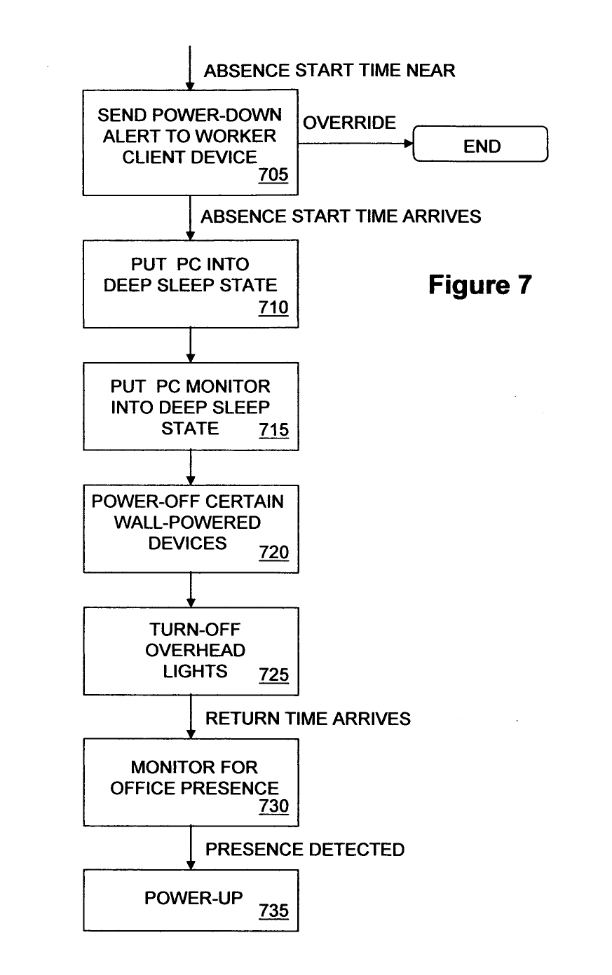

FIG. 7 shows method steps performed by power manager 130 to adjust a power state of managed elements in an office of a worker during and after a scheduled medium-term absence in some embodiments of the invention. The managed elements in this example are once again a PC, a PC monitor, certain wall-powered appliances and overhead lights in the worker's office.

Power manager 130 continually monitors scheduled event list 360 for event start times. At a predetermined time before a start time of a scheduled absent worker event, power manager 130 transmits a power-down alert to an alert address designated in the worker's schedule profile (705).

If power manager 130 receives an override notification before the event start time, power state adjustments to the worker's managed elements are canceled.

If power manager 130 does not receive an override notification before the event start time, power state adjustments proceed at the event start time in accordance with medium-term absence power profile 324 as follows: Power manager 130 puts the worker's PC into a deep sleep state (710), puts the worker's PC monitor into a deep sleep state (715), powers-off the worker's wall-powered appliances (720) and turns-off the worker's overhead lights (725).

When the event end time arrives, power manager 130 begins to monitor presence sensors 210 for human presence in the worker's office (630). Once power manager 130 detects presence, power manager 130 performs power state readjustments that power-up the worker's managed elements. For example, power manager 130 may return the workers PC, PC monitor, wall-powered appliances and/or overhead lights to a full power state.

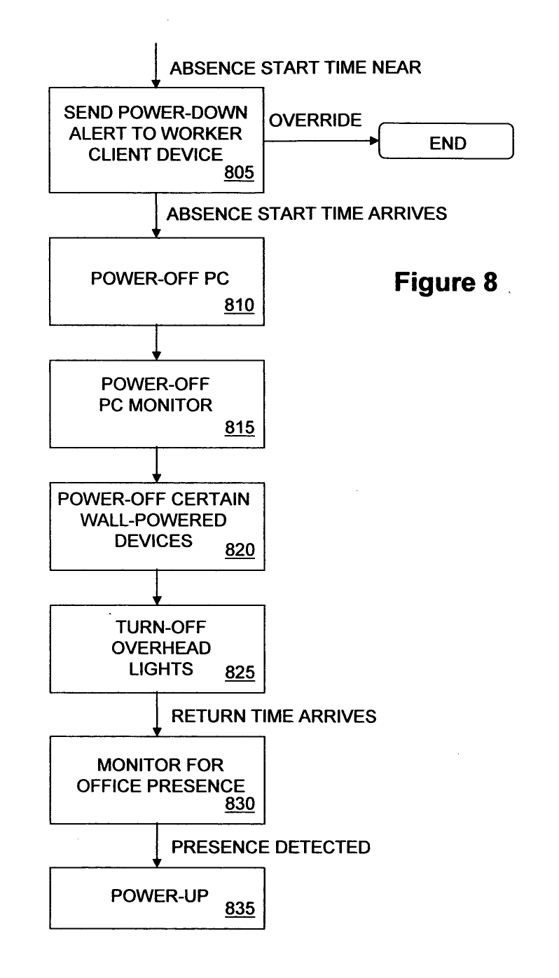

FIG. 8 shows method steps performed by power manager 130 to adjust a power state of managed elements in an office of a worker during and after a scheduled long-term absence in some embodiments of the invention. The managed elements in this example are once again a PC, a PC monitor, certain wall-powered appliances and overhead lights in the worker's office.

Power manager 130 continually monitors scheduled event list 360 for event start times. At a predetermined time before a start time of a scheduled absent worker event, power manager 130 transmits a power-down alert to an alert address designated in the worker's schedule profile (805).

If power manager 130 receives an override notification before the event start time, power state adjustments to the worker's managed elements are canceled.

If power manager 130 does not receive an override notification before the event start time, power state adjustments proceed at the event start time in accordance with long-term absence power profile 326 as follows: Power manager 130 powers-off the worker's PC (810), PC monitor (815) and wall-powered appliances (820), and turns-off the overhead lights (825).

When the worker absence event end time arrives, power manager 130 begins to monitor presence sensors 210 for human presence in the worker's office (830). Once power manager 130 detects presence, power manager 130 performs power state readjustments that power-up the worker's managed elements. For example, power manager 130 may return the worker's PC, PC monitor, wall-powered appliances and/or overhead lights to a full power state.

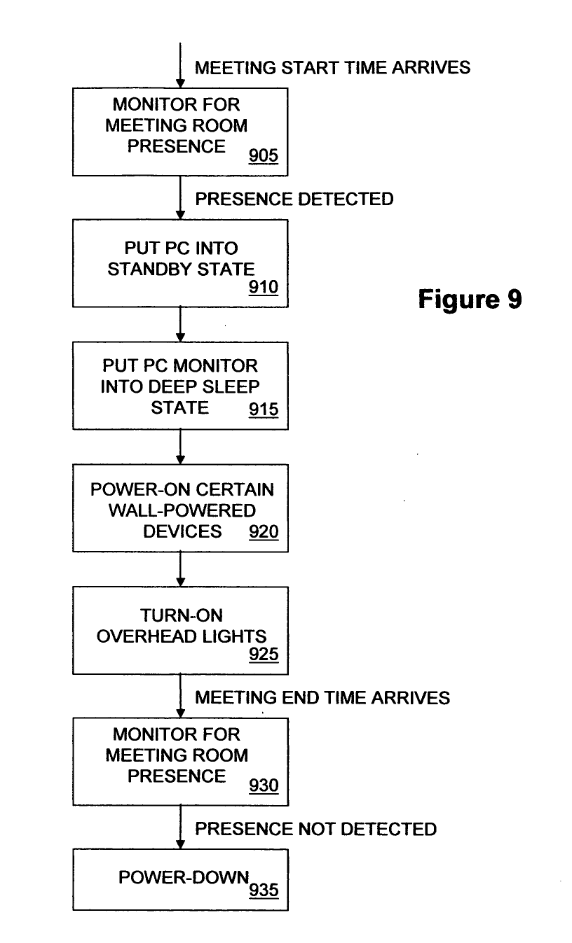

FIG. 9 shows method steps performed by power manager 130 to adjust a power state of managed elements in a meeting room during and after a scheduled meeting in some embodiments of the invention. The managed elements in this example are a meeting room PC, a meeting room PC monitor, certain wall-powered appliances (e.g. conferencing phone) in the meeting room and overhead lights in the meeting room.

Power manager 130 continually monitors scheduled event list 360 for meeting event start times. When a meeting event start time arrives, power manager 130 begins to monitor presence sensors 210 for human presence in the meeting room (905). Once power manager 130 detects presence, power manager 130 performs power state readjustments to the meeting room managed elements in accordance with meeting power profile 330 that power-up managed elements as follows: Power manager 130 puts the meeting room PC into a standby state (910), puts the meeting room PC monitor into a deep sleep state (915), powers-on the meeting room wall-powered appliances (920) and turns-on the meeting room overhead lights (925).

When the meeting event end time arrives, power manager 130 begins to monitor presence sensors 210 for human presence in the meeting room (930). If power manager 130 does not detect presence after a predetermined time, power manager 130 performs power state readjustments that power-down the meeting room managed elements (935). For example, power manager 130 may return the meeting room PC, PC monitor, wall-powered appliances and/or overhead lights to a powered-off state.

In other embodiments, power manager 210 may continually monitor during the meeting event for an early end to the meeting, such as by monitoring for a lack of motion detection for a predetermined time or manual turn-off of the meeting room overhead lights, and may perform power state readjustments that power-down the meeting room managed elements before the scheduled meeting end time in response to detecting an early end to the meeting.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A method for enterprise power management, comprising the steps of:
receiving by a power manager from a plurality of client devices individual worker schedule information;
generating by the power manager based at least in part on the individual worker schedule information a list of scheduled events having associated managed elements and power profiles; and in response to a start time of a scheduled event,
adjusting by the power manager a power state of one or more managed elements associated with the scheduled event in accordance with a power profile associated with the scheduled event.

2. The method of claim 1, wherein the power manager conditions adjustment of the power state on a detection of presence.

3. The method of claim 1, wherein the power manager alerts a client device associated with the scheduled event and provides an opportunity to override the adjustment.

4. The method of claim 1, further comprising, in response to an end time of a scheduled event, readjusting by the power manager a power state of one or more managed elements associated with the scheduled event.

5. The method of claim 4, wherein the power manager conditions readjustment of the power state on a detection of presence.

6. The method of claim 4, wherein the power manager alerts a client device associated with the scheduled event and provides an opportunity to override the readjustment.

7. The method of claim 1, wherein the power manager selects power profiles for scheduled events based at least in part on event duration.

8. The method of claim 1, wherein the scheduled event is an absent worker event, and wherein the adjusting step comprises, in response to a start time of the absent worker event, adjusting by the power manager the power state of one or more managed elements in an office of a worker scheduled to be absent.

9. The method of claim 1, wherein the scheduled event is a meeting event, and wherein the adjusting step comprises, in response to a start time of the meeting event, adjusting by the power manager the power state of one or more managed elements in a meeting room where a meeting is scheduled to be held and adjusting by the power manager the power state of one or more managed elements in an office of a worker scheduled to attend the meeting.

10. The method of claim 1, wherein the individual worker schedule information is generated by calendaring software running on the client devices.

11. The method of claim 1, wherein the one or more managed elements include a personal computer (PC), a PC monitor and an overhead light.

12. The method of claim 1, wherein the power manager adjusts the power state of one or more managed elements to a reduced power state.

13. A power manager, comprising:
a plurality of communication interfaces; and
a processor communicatively coupled with the communication interfaces, wherein under control of the processor the power manager receives from a plurality of client devices via one or more of the communication interfaces individual worker schedule information and generates based at least in part on the individual worker schedule information a list of scheduled events having associated managed elements and power profiles, and wherein under control of the processor in response to a start time of a scheduled event the power manager adjusts using signals transmitted on one or more of the communication interfaces a power state of one or more managed elements associated with the scheduled event in accordance with a power profile associated with the scheduled event.

14. The power manager of claim 13, wherein under control of the processor power manager conditions adjustment of the power state on a detection of presence.

15. The power manager of claim 13, wherein under control of the processor the power manager alerts a client device associated with the scheduled event and provides an opportunity to override the adjustment.

16. The power manager of claim 13, wherein under control of the processor the power manager selects power profiles for scheduled events based at least in part on event duration.

17. The power manager of claim 13, wherein the scheduled event is an absent worker event, and wherein under control of the processor in response to a start time of the absent worker event the power manager adjusts using signals transmitted on one or more of the communication interfaces the power state of one or more managed elements in an office of a worker scheduled to be absent.

18. The power manager of claim 13, wherein the scheduled event is a meeting event, and wherein under control of the processor in response to a start time of the meeting event the power manager adjusts using signals transmitted on or more of the communication interfaces the power state of one or more managed elements in a meeting room where a meeting is scheduled to be held and the power state of one or more managed elements in an office of a worker scheduled to attend the meeting.

19. The power manager of claim 13, wherein the individual worker schedule information is generated by calendaring software running on the client devices.

20. The power manager of claim 13, wherein the one or more managed elements include a PC, a PC monitor and an overhead light and wherein the power manager adjusts the power state of the PC, PC monitor and overhead light to a reduced power state.
